(19) United States
(12) Patent Application Publication
(10) Pub. No.: US 2015/0252840 A1
(43) Pub. Date: Sep. 10, 2015

(54) BEARING LUBRICATED WITH A MEDIUM

(71) Applicant: SCHAEFFLER TECHNOLOGIES GMBH & CO. KG, Herzogenaurach (DE)

(72) Inventors: Nico Kirchhoff, Schwebheim (DE); Christian Schulte-Nolle, Bamberg (DE); Thomas Loesche, Wipfeld (DE); Rupert Stitzinger, Bergrheinfeld (DE); Irina Suske, Herzogenaurach (DE)

(21) Appl. No.: 14/435,308

(22) PCT Filed: Sep. 17, 2013
(86) PCT No.: PCT/DE2013/200178

§ 371 Date: Apr. 13, 2015

(30) Foreign Application Priority Data
Oct. 12, 2012 (DE) 10 2012 218 619.0

(51) Int. Cl. F16C 19/52; C23F 13/00; F16C 33/66

(52) U.S. Cl. CPC F16C 19/52; F16C 33/6637; C23F 13/005

(57) ABSTRACT

A bearing lubricated with a medium, particularly a roller bearing or sliding bearing, including two bearing rings (1, 2) and a bearing path (3, 4) arranged on each of these bearing rings (1, 2), and a sacrificial anode (6) that is associated with at least one of the two bearing rings (1). The problem addressed is that of providing a bearing lubricated with a medium and including a sacrificial anode, the operational behavior of the bearing being only slightly influenced by the sacrificial anode. According to the invention, this is achieved in that the sacrificial anode (6) is arranged outside of the bearing interior (7) which is formed between the bearing rings (1, 2); and the sacrificial anode (6) is connected to the bearing interior (7) in an electrically-conductive manner.

### FIELD OF THE INVENTION

### Background

The invention relates to a bearing lubricated with a medium.

From practice, so-called bearings lubricated with medium are known, wherein the liquid medium surrounding the bearing flows through and in particular lubricates these bearings. The surrounding medium can be, in particular, an electrolyte, especially water, in particular, salt water, that causes, due to its chloride ions, a corrosion of the material of the bearing rings of the bearing, if certain corrosion-resistant materials, which are, however, not economical in use, are not provided for the bearing rings. In particular, rolling bearing steel in salt water is subject to corrosion, especially pitting corrosion, in its profile, especially the bearing paths of the rolling bearing, namely the raceways of the rolling bodies of the rolling bearing, and is damaged after a short time, if suitable measures against the corrosion have not been provided.

From practice it is basically known to connect, in an electrically conductive manner, a component subject to corrosion to a sacrificial anode made from an electrochemically less noble material than the component to be protected, so that the material of the sacrificial anode corrodes and is dissolved instead of the material of the component.

WO 2009/135482 A2 describes, as the last embodiment (FIG. 10), a bearing formed as a rolling bearing lubricated with a medium, water, in particular, salt water, with two bearing rings and a bearing path that is arranged on each bearing ring and is formed as a rolling path for rolling bodies, wherein, between the two bearing rings, a bearing intermediate space is defined that is limited by the outer lateral surface of the inner bearing ring and the inner lateral surface of the outer bearing ring. A sacrificial anode is allocated to each of the two bearing rings, wherein each sacrificial anode is held as a ring-shaped component on the lateral surfaces facing each other and defining the bearing intermediate space in a respective groove so that each sacrificial anode is arranged in the direct vicinity of the bearing path to be protected, namely each running surface of the rolling bodies. Here it is disadvantageous that during the dissolving of the sacrificial anode caused by corrosion, which can be made, for example, from zinc, products such as zinc hydroxide can be formed close to the raceways as so-called white rust and can be deposited partially on the raceways. It is further unfavorable that the sacrificial anodes that are consumed during the operation of the rolling bearing are expensive to replace. It is also unfavorable that the grooves next to the raceways weaken the bearing ring as a whole.

### SUMMARY

The object of the invention is to disclose a bearing lubricated with a medium with a sacrificial anode, whose operating behavior is only slightly influenced by the sacrificial anode.

This object is solved according to the invention for the bearing specified above in that the sacrificial anode is arranged outside of the bearing interior formed between the bearing rings and the sacrificial anode is connected to the bearing interior in an electrically conductive manner.

The at least one sacrificial anode is arranged electrically conductive, for example, in the surroundings of the bearing, relative to the bearing ring that is allocated to this sacrificial anode and is to be protected by this sacrificial anode and takes up no space in the bearing interior, that is, in the area between the two bearing rings. The electrically conductive connection to the bearing interior ensures that the bearing interior is protected with the bearing path, wherein the lubricating medium acts as an electrolyte.

Products, such as zinc hydroxide, generated during the dissolving of the material of the sacrificial anode due to corrosion are produced outside of the bearing, at a distance from the bearing paths that are sensitive to foreign particles. Furthermore, the at least one sacrificial anode can have a large structure and provided with a volume of a material that is significantly larger than the ultimately limited installation space in the bearing interior, so that the sacrificial anode can provide its function for a longer period of time.

Furthermore, an arrangement of the sacrificial anode outside of the bearing interior simplifies the replacement of the sacrificial anode in the event of maintenance.

Advantageously it is provided that the sacrificial anode is arranged on an end face of one of the two bearing rings. In particular, the at least one sacrificial anode is arranged on an easily accessible end face of the stationary of the two bearing rings.

Alternatively or additionally, the sacrificial anode or another sacrificial anode could be spaced apart from the bearing and spatially separated from the bearing rings on a surrounding construction, in particular, in a container provided specifically for holding the sacrificial anode.

Preferably it is provided that the end faces and the lateral surfaces turned away from the bearing interior of at least one of the two bearing rings, especially both bearing rings, have electrical insulation. The electrical insulation ensures that the sacrificial anode protects only the bearing ring allocated to this sacrificial anode, but not the bearing surroundings adjacent to the bearing ring. As the material of the insulation, a ceramic material, a polymer such as Teflon or PEEK (polyether ether ketone), a polymer coating, a composite material on a polymer basis (e.g., a fiber-reinforced plastic, in particular a cured compound made from a fiber-reinforced resin such as phenol resin or epoxy resin) or a glass material could be provided; the insulation could be formed as a separate component that is fastened on the end faces or the lateral surface turned away from the bearing interior for the bearing ring allocated to the sacrificial anode, or as a coating of the surface of the bearing ring. It is understood that the hole of the bearing mount in which the bearing ring is fastened or the surface of the shaft on which the bearing ring is arranged also has electrical insulation.

Preferably it is provided that the electrically conductive connection of the sacrificial anode to the bearing interior comprises an insulated conductor cable.

Preferably it is provided with respect to the conductor cable that the sacrificial anode is connected to the electrical conductor of the conductor cable by an electrically conductive adhesive, an electrically conductive solder layer, or a press fit.

Preferably it is provided that the conductor cable ends in the bearing interior in a ring electrode that runs essentially parallel to a bearing path of one of the bearing rings. The ring electrode ensures that the critical area of the bearing path is held along its extent at the same electrochemical potential and in particular pitting corrosion can find no starting point.

Preferably it is provided that the sacrificial anode is connected in an electrically conductive manner only to one of the two bearing rings and that an electrical contact, in particular, a sliding contact, is formed between the bearing ring connected to the sacrificial anode and the other bearing ring. The sliding contact can be formed, in particular, by graphite brushes.

Other advantages and features of the invention are given from the dependent claims and from the description of an embodiment.

The invention is described and explained in more detail below with reference to the accompanying drawing.

### BRIEF DESCRIPTION OF THE DRAWINGS

FIG. 1 shows schematically a partially sectioned view of an embodiment of a bearing lubricated with a medium according to the invention.

### DETAILED DESCRIPTION OF THE PREFERRED EMBODIMENTS

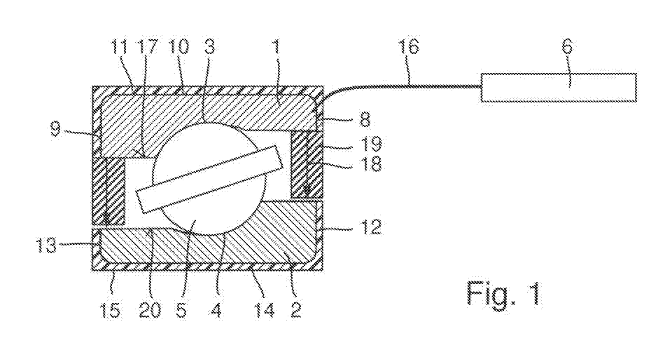

FIG. 1 shows a bearing formed as a rolling bearing, comprising a first bearing ring 1 formed as an outer ring and also a second bearing ring 2 formed as an inner ring, wherein a bearing path 3, 4 formed as a rolling path for rolling bodies 5 of the rolling bearing is provided on each of the two bearing rings 1, 2.

The bearing is formed as a bearing lubricated with a medium, so the surrounding liquid medium passes through it, wherein the surrounding medium lubricates the bearing paths 3, 4; the surrounding medium is, in particular, water, especially a salt water that is corrosive due to the chloride ions and attacks the material of the bearing rings 1, 2, namely a rolling bearing steel, with pitting corrosion and can dissolve the material at certain points, in particular, in the vicinity of the bearing paths 3, 4.

The bearing further comprises a sacrificial anode 6 that is allocated to the first bearing ring 1, namely is connected in an electrically conductive manner to the first bearing ring 1 so that the material of the sacrificial anode 6, for example, zinc or zinc aluminum, is dissolved by corrosion instead of the rolling bearing steel of the first bearing ring 1.

For the sacrificial anode 6 it is provided that the sacrificial anode 6 is arranged outside of the circular ring-shaped bearing interior 7 formed between the bearing rings 1, 2 and that the sacrificial anode 6 is connected in an electrically conductive manner to the bearing interior 7.

The rod-shaped sacrificial anode 6 is arranged outside of the bearing, spaced apart from the two bearing rings 1, 2 of the bearing, on a section of a housing, for example, held in a receptacle groove in the housing or in a component that is provided for holding the sacrificial anode and is fastened to the housing.

In the shown embodiment, the sacrificial anode 6 is spaced apart by electrical insulation 11 from the bearing ring 1, wherein the insulation 11 is penetrated by an electrical conductor. In particular, it is provided that the end faces 8, 9 and the outer lateral surface 10 of the first bearing ring 1 turned away from the bearing interior 7 have electrical insulation 11 from the housing and thus from the sacrificial anode 6 held on the housing, wherein the outer lateral surface 10 of the first bearing ring 1 is fastened to the housing in a housing hole. The electrical insulation 11 is formed as a coating on the end faces 8, 9 and also the outer lateral surface of the first bearing ring 1 pointing away from the bearing interior 7, wherein the coating is formed from a ceramic or a plastic and is selected so that the material of the coating exhibits only slight swelling behavior in the surrounding medium.

For the second bearing ring 2 it is also provided that the end faces 12, 13 and the inner lateral surface 14 turned away from the bearing interior 7 have electrical insulation 15. Thus, the second bearing ring 2 is formed electrically insulated from a not-shown shaft, wherein the rolling body 5 can be made from an electrically conductive metal or a ceramic.

So that the sacrificial anode 6 is connected in an electrically conductive manner to the bearing interior 7 it is provided that the electrically conductive connection of the sacrificial anode 6 to the bearing interior 7 comprises an insulated conductor cable 16. The insulated conductor cable 16 comprises a copper conductor and a plastic insulation surrounding the copper conductor. The conductor cable 16 passes through the insulation 11 of the first bearing ring 1 at its first end face 8 and creates an electrically conductive contact between the sacrificial anode 6 and the first bearing ring 1. A first end of the conductor cable 16 is connected in an electrically conductive manner to the sacrificial anode 6 so that the electrically conductive material of the sacrificial anode 6 is connected in an electrically conductive manner to the electrical copper conductor of the conductor cable 16 by an electrically conductive adhesive, a press fit, or an electrically conductive solder layer. The second end of the conductor cable 16 is held in a blind hole provided in the metallic body of the first bearing ring 1, wherein the copper conductor contacts the base of the blind hole in an electrically conductive manner, so that an inner lateral surface 17 of the first bearing ring 1, which is uncoated at least in some sections, especially adjacent to the bearing path 3, and borders the bearing interior 7 at one side and has no coating, is electrochemically protected by the sacrificial anode 6. The blind hole is otherwise filled with a material that ensures that rust does not form at the contact point of the second end of the conductor cable to the material of the first bearing ring 1. At the inner lateral surface 17 of the first bearing ring 1, the corrosive salt water comes directly in contact with the rolling bearing steel that is susceptible to corrosion in the first bearing ring 1, but essentially no corrosion takes place at the inner lateral surface 17 due to the electrically conductive connection to the sacrificial anode 6.

In the shown embodiment it is provided that the sacrificial anode 6 is connected in an electrically conductive manner directly only to the first bearing ring 1 and an electrical contact 18, namely a sliding contact, in particular, brush contact made from graphite, is formed between the first bearing ring 1 connected directly to the sacrificial anode and the second bearing ring 2. The contact 18 is held within a sealing material 19 that acts as a pre-filter and suppresses penetration of contaminating material into the bearing interior 7.

The contact 18 connects the metallic surface of the inner lateral surface 17 of the first bearing ring 1 to the similarly metallic surface of the outer lateral surface 20 of the second bearing ring 2, wherein the two lateral surfaces 17, 20 border the bearing interior on both sides and define an annular, surrounding bearing gap in the shown radial bearing.

It is understood that at least one of the two lateral surfaces 17, 20 of the bearing rings 1, 2 bordering the bearing interior 7, especially at a distance to the bearing path 3, 4, can have a passive, corrosion-inhibiting coating.

It is further understood that the second end of the cable conductor 16 does not have to end at the base of a blind hole of the first bearing ring 1, but instead can end in a ring electrode, wherein the ring electrode runs parallel to the bearing paths 3, 4.

It is also understood that more than one cable conductor 16 could be provided that connects the sacrificial anode 6 to the first bearing ring 1. It is further possible that both bearing rings 1, 2 are connected with a common sacrificial anode 6 to at least one electrical conductor; the common sacrificial anode 6 is here arranged, for example, on the end face on the stationary bearing ring and connected in an electrically conductive manner, for example, via a sliding contact to the rotating bearing ring.

In the embodiment described above, the sacrificial anode 6 is arranged spatially separated from the bearing. It is understood that the sacrificial anode 6 could be arranged on an end face 8 of the first bearing ring 1, electrically insulated from this by the insulation 11 in the area of the end face 8, and connected in an electrically conductive manner by a short electrical conductor to the conductive body of the first bearing ring 1. The electrical conductor can here be formed by a short cable conductor or by a plug-in connection.

In the embodiment described above, the bearing was formed as a rolling bearing, namely a single row angular contact ball bearing whose bearing paths 3, 4 were raceways for the rolling bodies 5. It is understood that the bearing could also be formed as a sliding bearing whose bearing paths are sliding surfaces that are in such close contact that a sacrificial anode can be barely arranged between the sliding surfaces so that the proposed arrangement of the sacrificial anode outside of the bearing interior of the sliding bearing limited by the sliding surfaces makes it possible to provide durable corrosion protection for a sliding bearing lubricated with a medium.

In one case in which a bearing path formed as a rolling path or a sliding surface is machined directly into the surface of a shaft or a surface of a hole of a bearing housing, the shaft provided with the bearing path or the housing provided in the area of the bearing hole with the bearing path can be seen as a “bearing ring” in the sense of the invention described above.

### LIST OF REFERENCE NUMBERS

1 First bearing ring
2 Second bearing ring
3 Bearing path of the first bearing ring 1
4 Bearing path of the second bearing ring 2
5 Rolling body
6 Sacrificial anode
7 Bearing interior
8 End face of the first bearing ring 1
9 End face of the first bearing ring 1
10 Outer lateral surface of the first bearing ring 1
11 Electrical insulation
12 End face of the second bearing ring 2
13 End face of the second bearing ring 2
14 Inner lateral surface of the second bearing ring 2
15 Electrical insulation
16 Conductor cable
17 Inner lateral surface of the first bearing ring 1
18 Contact
19 Sealing material
20 Outer lateral surface of the second bearing ring 2

1. A bearing lubricated with a medium, comprising
two bearing rings and a bearing path arranged on each of the respective bearing rings, and
a sacrificial anode that is allocated to at least one of the two bearing rings,
wherein the sacrificial anode is arranged outside of a bearing interior formed between the bearing rings, and
the sacrificial anode is connected to the bearing interior in an electrically conductive manner.

2. The bearing lubricated with a medium according to claim 1, wherein the sacrificial anode is arranged on an end face of one of the two bearing rings.

3. The bearing lubricated with a medium according to claim 1, wherein the bearing rings each include end faces and lateral surfaces turned away from the bearing interior, and electrical insulation is located on at least one of the end faces or the lateral surfaces of at least one of the two bearing rings.

4. The bearing lubricated with a medium according to claim 1, wherein the electrically conductive connection of the sacrificial anode to the bearing interior includes an insulated conductor cable.

5. The bearing lubricated with a medium according to claim 4, wherein the sacrificial anode is connected to an electrical conductor of the conductor cable by an electrically conductive adhesive, an electrically conductive solder layer, or a press fit.

6. The bearing lubricated with a medium according to claim 4, wherein the conductor cable ends in a bearing interior in a ring electrode that runs essentially parallel to a bearing path of one of the bearing rings.

7. The bearing lubricated with a medium according to claim 1, wherein the sacrificial anode is connected to one of the two bearing rings in an electrically conductive manner and an electrical contact is formed between the bearing ring connected to the sacrificial anode and the other bearing ring.

8. The bearing lubricated with a medium according to claim 1, wherein the sacrificial anode is arranged at a distance with respect to an end face of the bearing ring by insulation and the insulation is passed through by an electrical conductor that connects the sacrificial anode and the bearing ring in an electrically conductive manner.

9. The bearing lubricated with a medium according to claim 1, wherein the electrical contact is a sliding contact.
